(19) United States
(12) Patent Application Publication
(10) Pub. No.: US 2004/0050191 A1
(43) Pub. Date: Mar. 18, 2004

(54) Internal propulsion apparatus of closed system utilizing Coriolis force

(76) Inventor: Byung-Tae Chung, Incheon-Shi (KR)

Correspondence Address: Peter T. Kwon, G W i P S, Kangnam P.O. Box 2301, Seoul, 135-242, KR

(21) Appl. No.: 10/461,472

(22) Filed: Jun. 16, 2003

(30) Foreign Application Priority Data
Jul. 10, 2002 (KR) 2002-0039880

(51) Int. Cl. F16H 33/20

(52) U.S. Cl. 74/84 S

(57) ABSTRACT

An internal propulsion apparatus of a closed system utilizing the Coriolis force is provided to generate locomotion without external force. The internal propulsion apparatus comprises: a closed body (10) with a hollow interior; a guide (72) having a plurality of slots along its cylindrical-shape of lateral surface, the guide (72) being installed inside of the body (10) and eccentrically disposed from the center of the body (10); a power motor (71) installed at the center of the body (10) and disposed perpendicular to the guide (10); a plurality of spokes (39a) outwardly and radially coupled to the shaft end of the power motor (71) for rotating along with the power motor (71), the spokes (39a) being pierced through the slots of the guide (72) and arranged radially around the guide (72) in certain intervals; and a plurality of core masses (63˜70), arranged in each partition and restricted by the spokes (39a) and the guide (72), for rotating with constant angular velocity by rotation of the spokes (29a) and the guide (72). Thus, the internal propulsion apparatus operate not only in a gravitational field, but also in a gravity-free vacuum state, a benefit for the coming space age, by utilizing the Coriolis force (Fc) in a closed system.

### BACKGROUND OF THE INVENTION

1. Field of the Invention

The present invention relates to an internal propulsion apparatus which is capable of linearly moving a closed system, without external force, by generating the Coriolis force in the closed system. Particularly, the Coriolis force (fc) represents the forces acting on the total center of mass (TCM) in an inertial coordinate system when the observed masses (M1, M2) located at certain radii (r) from the center of mass in an angular coordinate system rotate with a constant angular velocity (ω) while the radii of the masses are simultaneously varied.

2. Related Prior Art

As a conventional technology, U.S. Pat. No. 6,109,123, entitled “Rotational Inertial Motor,” discloses an internal propulsion device of a closed system.

The reference describes that an inertial drive unit utilizes the reaction of an apparatus to the longitudinal component of the radial acceleration of rotating masses internal to the apparatus. Particularly, the internal radial acceleration of masses driven by circular motion is induced along a linear path, so it creates a reaction force that moves the apparatus in a perpendicular direction, far away from the axis of rotation of the internal constituents of the apparatus.

In the above reference, the vector acceleration of mass in the conventional technology is represented as follows:

a=(a−rω²)ρ+(2vω+rα)θ

wherein, a is scalar radial acceleration, d²r/dt², and α is scalar angular acceleration, d²c/dt².

Generally, these four accelerations are known as radial acceleration, centripetal acceleration, Coriolis acceleration and angular acceleration. Each acceleration causes a reaction force, F=−ma, wherein the minus sign represents the fact that the accelerations are detected as reactions in a rotating system. Therefore, inertial forces are presented in order to define the radial acceleration force, the centrifugal force, the Coriolis force, and the angular acceleration force. In the prior art, the acceleration (a) and velocity (v) were zero, and its effect relies upon ω and α. The effect of the cited reference relies primarily upon the radial acceleration force (a) and the Coriolis force 2vω (i.e., the forces that result from the radial motion of masses).

However, an important aspect of this reference is that, because the above equation interprets the acceleration representing the total acceleration of the inertial system and the non-inertial system as being not equal to zero (a=/=0), it describes the operation of the apparatus as initially deviating from Newton's Law. Although the Coriolis force and the angular acceleration force are defined as non-inertial forces in this reference, these forces are treated as if the inertial force is generated by external forces. Therefore, the apparatus of this reference cannot achieve the expected mobility.

Because radial acceleration and centripetal acceleration are types of inertial forces, these forces cancel each other out in a rotating system and generate a standstill vibration without linear movement for a vehicle. The above reference misrepresents that mobility is generated by radial acceleration. It is incorrect to assert that these forces may achieve locomotive power.

As another reference, U.S. Pat. No. 6,289,263 entitled “Spherical Mobile Robot” discloses a mobile robot, particularly a robot having a spherical exo-skeleton with an internal propulsion mechanism. This spherical robot can roll over rugged terrain because it is equipped with devices that control its position and direction. The technology and structure of the rolling spherical robot is quite different from a wheeled robot. A rolling sphere enables the mobile robot to traverse rough terrain.

Since the rolling robot having a spherical exo-skeleton relies on an internal mechanism for propulsion, the size of the sphere may be adjusted, depending on the requirement. Increasing the diameter of the spherical robot increases both its capability of traversing rough terrain as well as its payload capacity.

The driving mechanism described in this reference provides continuous mobility by spinning the masses in the spherical body, thus creating momentum with respect to the center of the sphere, and thereby enabling the spherical body to accelerate and decelerate, to operate with constant velocity, or to servo at a certain point, depending on necessity. The motion of spherical body is controlled through sensing and feedback.

This spherical robot has a high stability and rapid maneuverability for traversing rough terrain. This robot is provided with self-control capability, and is equipped with an internal power supply as well as a microprocessor for motion and hardware control through sensors that provide feedback. The spherical robot has excellent mobility compared to that of a wheeled robot because its spherical body can roll in any direction. Furthermore, the radius of the spherical body is larger than the exterior size of a wheeled robot.

However, the spherical mobile robot (SMR) rolls under the influence of gravity. Since rolling occurs only by gravitational force with friction, the center of gravity for the rolling object is continually relocated as the center of mass (CM) rolls. However, the spherical mobile robot is designed without regard to the concepts of opened and closed movements, and it is impossible to obtain locomotion in space, a frictionless, gravity-free vacuum state.

Even though the rolling device of the above reference is a rotating system, it is designed to roll in any direction without regard to linear movement by the Coriolis force.

### SUMMARY OF THE INVENTION

An objective of the present invention is to provide an internal propulsion apparatus of a closed system utilizing the Coriolis force, the apparatus comprises: a closed body (10) with a hollow interior; a guide (72) having a plurality of slots along its cylindrical shape of lateral surface, the guide (72) being installed inside of the body (10) and being eccentrically disposed from the center of the closed body (10); a power motor (71) installed at the center of the closed body (10) and disposed perpendicular to the closed body (10); a plurality of spokes (39a) outwardly and radially coupled to the shaft end of the power motor (71) for rotating along with the power motor (71), the spokes (39a) being pierced through the slots of the guide (72) and arranged radially around the guide (72) in certain intervals; and a plurality of core masses (63˜70) arranged in each partition and restricted by the spokes (39a) and the guide (72) for rotating with constant angular velocity by rotation of the spokes (29a) and the guide (72).

Another objective of the present invention is to provide an internal propulsion apparatus of a closed system utilizing the Coriolis force, the apparatus comprises: a closed body (10) with a hollow interior; a cylindrical guide (72) installed inside of the body (10); a power motor (71) perpendicularly installed at the center of the body (10); an inner guide (87) having a plurality of slots along the cylindrical shape of lateral surface; the inner guide (87) installed inside of the cylindrical guide (72) to form a partition and eccentrically disposed from the center of the cylindrical guide (72); an outer guide (86) having a plurality of slots along the cylindrical shape of lateral surface, the outer guide (86) being installed inside of the cylindrical guide (72) to form a partition and being eccentrically disposed from the center of the cylindrical guide (72); a plurality of spokes (39a) outwardly and radially coupled to the shaft end of the power motor (71) for rotating along with the power motor (71), the spokes (39a) being pierced through the slots of the inner and outer guides (86, 87) and arranged radially around the inner and outer guides (86, 87) in certain intervals; and a plurality of core masses (63˜70) arranged in each partition and restricted by the spokes (39a) and the inner and outer guides (86, 87), for rotating with constant angular velocity by rotation of the spokes (29a) and the inner and outer guides (86, 87).

It is desirable that the closed body forms a dual system with oppositely rotating upper and lower power motors (94, 95) connected through a gear train (99).

A purpose of this invention is to provide an internal propulsion apparatus that enables mobility not only in a gravitational field, but also in a frictionless, gravity-free vacuum state.

Another purpose of this invention is to provide a closed system utilizing the Coriolis force, for obtaining linear movement and directional control means so that the direction of a moving body may be freely changed.

Another purpose of this invention is to provide a closed system that does not exchange foreign objects, and therefore does not contribute to environmental pollution.

### BRIEF DESCRIPTION OF THE DRAWINGS

FIG. 1a is a conceptual drawing illustrating the concept of operation in an open system.

FIG. 1b is a conceptual drawing illustrating the concept of operation in a closed system according to the present invention.

FIG. 2 is a force exertion diagram representing the generated Coriolis force with time according to the present invention.

FIG. 3 is a vector diagram for a hemisphere type internal propulsion apparatus utilizing the Coriolis force according to the present invention.

FIG. 4 is a conceptual drawing illustrating a paired hemisphere type internal propulsion apparatus.

FIG. 5 is a schematic drawing illustrating a guided-control type single internal propulsion apparatus of this invention.

FIG. 6 is a cross section view illustrating both-sides of an inner guide type of single internal propulsion apparatus of this invention.

FIG. 7 is a cross section view illustrating both-sides of an inner guide type of paired internal propulsion apparatus of this invention.

FIG. 8 is a block diagram of control circuit for controlling the internal propulsion apparatus of this invention.

FIGS. 9a to 9c are the conceptual drawings illustrating relative combinations of paired internal propulsion systems in parallel, series and perpendicular, respectively.

FIG. 9a is a conceptual drawing illustrating a parallel combination for the paired internal propulsion system.

FIG. 9b is a conceptual drawing illustrating a series combination for the paired internal propulsion systems.

FIG. 9c is a conceptual drawing illustrating a perpendicular combination for the paired internal propulsion systems.

### DETAILED DESCRIPTION OF PREFERRED EMBODIMENT

In order to achieve the aforementioned objectives of this invention, a new concept of internal propulsion apparatus of closed system utilizing the Coriolis force is developed. The detailed description is presented hereafter accompany with drawings as follows:

First of all, it is necessary to define the conceptual movement of an opened system and a closed system in order to explain the characteristics of the Coriolis force, according to the present invention.

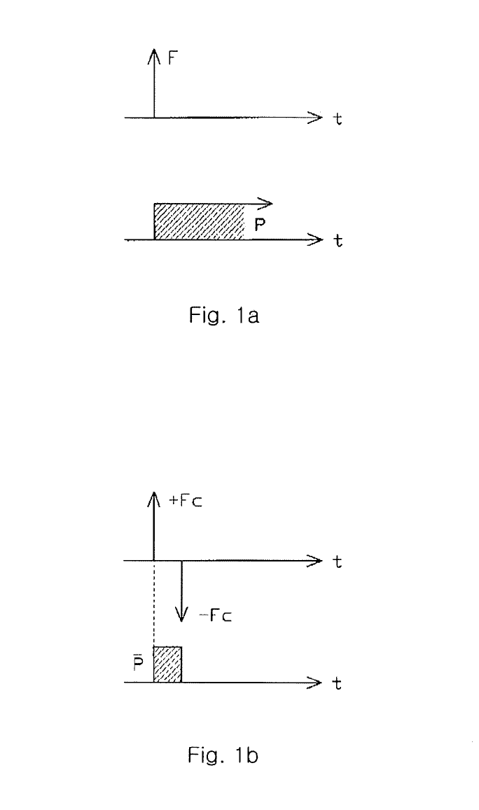

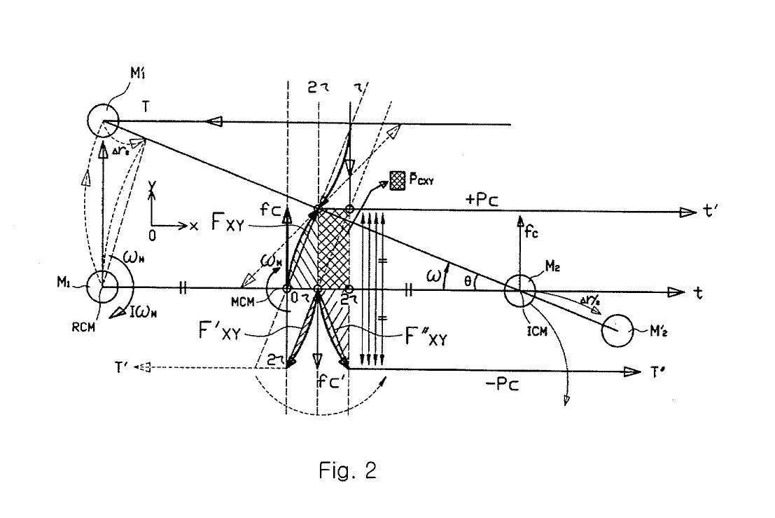

As illustrated in FIG. 2, there are two kinds of object moving means, i.e., opened movement and closed movement. Herein, opened movement occurs when an object is forced by external force (F) and continuously moved by inertial force. (As seen in FIG. 1, a Momentum (P) is continuously presented). On the other hand, closed movement occurs when an object is forced onward and rearward for a certain period of time (e) by coupled external forces (+F_{e,} −Fₑ). (As seen in FIG. 1b, a Momentum (\overline{P}) is momentarily presented, and vanishes.)

Accordingly, the force generating opened movement is inertial force, and the force generating closed movement is non-inertial force. The resulting momentum presents and then cancels each other out at opposite directions for a certain period of time.

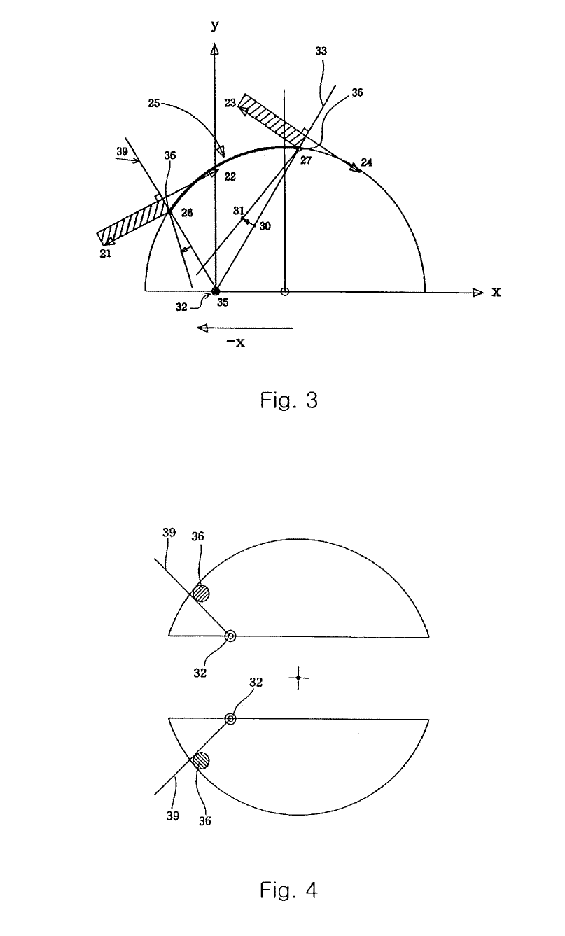

Referring to FIGS. 1 and 3, while mass 1 (M₁) is rotating with constant velocity to maintain a constant angular velocity (ω_{M}) of mass 1 (M₁) with respect to the rotating center of mass 1 (RCM), the radius (r) is simultaneously varied with Δr/2 and applies a torque [symbol] of lω_{M} to the rotating direction.

Then, a reaction force (f_{c}) is presented on mass 2 (M₂):

$$\text{?} = \text{?} \begin{matrix}ⅆ t \\ ⅆ t\end{matrix} - {ω}_{M} 2 \text{?} {M}_{2} - r \text{?} \\ \text{?} \text{indicates text missing or illegible when filed} \qquad ◯ 1$$

wherein, the force (f_{c}) represents the Coriolis force.

At this instance, mass 2 (M₂) will be momentarily stalled and becomes the rotation center of mass (RCM). Simultaneously, the radius (r) is increased from the rotation center of mass 1 (RCM), and a force (f_{c}) is presented at the mass center of masses (MCM), while the momentum energy is maintained constant (ω_{M}=constant) for τ seconds: as represented below.

[symbol]

After τ seconds, a reaction force is generated on mass 1 (M1) with respect to an instant center of mass (ICM), as follows;

[symbol]

When the axis f time is moved from T′ to T″, the forces [symbol] become [symbol] .

At this point, the centrifugal force and centripetal force are simultaneously generated, but the forces cancel each other out. When the angular velocity (ω) is constant, a relation is established, as follows:

[symbol]

When above equation α is integrated for τ seconds, wherein

$$\int \text{?} {\overline{F}}_{XY} \overline{δ} ( t ) ⅆ t - F \text{?} [ u ( t ) - u ( t - t ) ] - {\overline{P}}_{CXY} \\ \text{?} \text{indicates text missing or illegible when filed}$$

the equation β is a closed movement—that is, a Pulse movement.

When the equation α is again integrated for τ seconds, at

[symbol]

$$\int \text{?} {\overline{F} }_{XY} \overline{u} ( t ) ⅆ t {C}_{T} O$$

$$\text{?} \text{indicates text missing or illegible when filed}$$

—that is,

$$\int \text{?} {\overline{P}}_{CXY} ⅆ t {MT}^{xy} {{C}_{xy}}_{T} O . \\ \text{?} \text{indicates text missing or illegible when filed}$$

wherein, C=mass×distance, the amount of movement of the system with respect to the total center of mass (TCM) will be

$${L}^{\text{?}} \text{?} \frac{M \text{?}}{2 M} . \\ \text{?} \text{indicates text missing or illegible when filed}$$

In this manner, after the Pulse movements are generated, whenever multiple steps of the instant center of mass (ICM) occur, non-inertial separated movements can be obtained every τ seconds.

The more accurate value of F_{XY} is as follows:

$${F}_{XY} {\int }_{0}^{\text{?}} \text{?} cos θ ⅆ θ$$

$$\text{?} \text{indicates text missing or illegible when filed}$$

Therefore, it is necessary to supply energy when the radius (r) is extended and all masses are rotating with constant angular velocity (ω=constant) with respect to the rotating center of mass (RCM). Contrarily, if the radius (r) is decreased, an impulse of the Coriolis force (−fc) is generated due to the reverse energy supply or energy recovery. The Pulse movement as the closed movement is generated as a result of the alternative occurrence of rotating masses and the rotating center of mass (RCM).

As described above, when the masses (M1, M2), rotating with constant angular velocity (ω) at the center of mass (CM), and the radii (r), simultaneously varying, are placed in a closed system, it is possible to achieve linear movement for a closed system as the total center of mass (TCM) of the closed system moves forward.

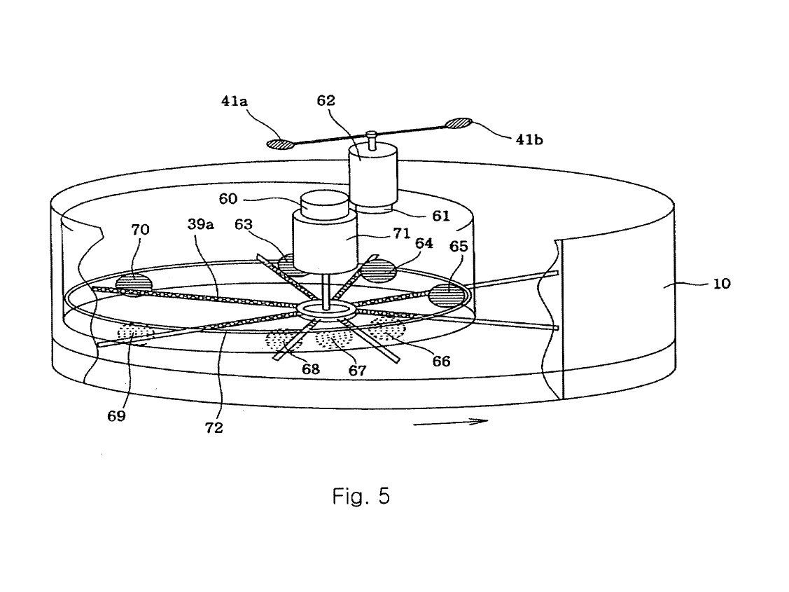

As seen in FIG. 5, an internal propulsion apparatus of the present invention is modeled. This model illustrates that Coriolis forces (fc: 21, 22, 23, 24) are presented on a trajectory of momentary Centroid (25) which is trajecting the momentary centers (26, 27) of the core mass (36). This model of the present invention illustrates the relationship between the momentary center (26, 27) and the Coriolis force (fc).

When a core mass M (35) in a system rotates with constant velocity (ω=constant) at a certain point of rotating axis (39), and the core mass M (35) is constantly moved away from the core mass m (36), an instant center of mass (ICM) (26, 27) is presented at a certain point of the core mass m (36). Then, Coriolis forces (fc: 21, 22, 23, 24) are generated at an instant center (ICM) of masses (26, 27) perpendicular to the axis of instant center (33, 39), connecting the rotating center (RCM) of mass (32) to the core mass m (36). The instant center (ICM) of masses (26, 27) is traced along the trajectory of momentary Centroid (25). Since Coriolis forces (f_{c}) are presented on the instant center (ICM) of masses (26, 27), the rotating center of mass (RCM) (32) will be traced along an arc with respect to the instant center (ICM) of mass (38) by reaction force. Consequently, the total center of core mass (TCM) (30) is moved forward (relocated from point 30 to point 31) as the mass center of masses (MCM) (30) is rotated with respect to the axis of the instant center (33).

In this case, the Coriolis forces (Fc) generated by action of the rotating center of mass (RCM) (32) and instant center of mass (ICM) (26, 27) first reacts in an inertial coordinate system and later reacts in a rotating coordinate system. That is, it is possible to apply the equation □ due to the occurrence of phase delay in time for action and reaction between the coordinate systems.

In the case where the radius (r) is varied and an angular velocity (ω) is constant, if the mass is separately accelerated on the rotating center of mass (RCM) (32), it could be described as shown in the following equation \mathring{1}

$$ⅆ I \begin{matrix}w \\ ⅆ r\end{matrix} = {τ}_{c} = \text{?}$$

$$\text{?} \text{indicates text missing or illegible when filed}$$

wherein, Fc is a temporarily presented resultant due to the inertial core mass I.

The core mass m (36) rotates clockwise with respect to the rotating center of mass (32) under the condition of extending the radius (r) simultaneously with constant angular velocity (ω=constant). In this situation, the overall closed system is moved in the −X direction. Sequentially, the core mass m (36) moves completely rightward, rotating counterclockwise under the condition of shortening the radius (r) simultaneously with constant angular velocity (ω=constant). In this situation, the overall closed system is also moved in the −X direction.

As shown in FIG. 4, an implementing example is illustrated for coupling a paired hemispheric internal propulsion system. In this situation, it has twice the effect as the single-hemispheric internal propulsion apparatus, so it has double the Coriolis force and movement.

A guided-control-type single internal propulsion apparatus is illustrated in FIG. 5. It has a substantially cylindrical-shape of closed body (10) with a hollow interior. It is tightly sealed so that foreign objects cannot penetrate and enter the closed system.

There is a cylindrical guide (72) installed inside of the body, a power motor shaft (71) installed above a spot eccentrically positioned from the center of the cylindrical guide (72), a plurality of spokes (39a) outwardly and radially coupled to the shaft and pierced through the cylindrical guide (72) and the spokes are rotatable circumferentially along the cylindrical guide (72).

Each core mass (63˜70) is internally installed at each partition inside of the cylindrical guide (72) and spokes (39), and rotates with constant angular velocity, along the cylindrical guide (72) by rotation of the spokes (39a).

Since each core mass (63˜70) restricted by the guide (72) is rotated by the spokes (39a), and the center of the rotating spokes (39a) is eccentric to the center of the guide (72), each radius of the rotating core masses (63˜70) varies from minimum to maximum at every revolution. While the power motor (71) is rotating with constant angular velocity, a non-inertial Coriolis force is generated at each momentary center of the core masses (63˜70). Consequently, the body (10) moves in the direction of the arrow as shown in FIG. 5.

A power motor sensor (60) is installed in the upper part of the power motor (71) for sensing the number of revolutions. Therefore, the rotating speed of the power motor (71) enables it to be controlled at a constant angular velocity.

A directional control motor (62) is installed on the upper surface of the guide (72). At the ends of the directional control motor shaft, the rotating core masses (41a, 41b) are installed to control direction of the closed body (10). When the core masses (41a, 41b) rotate leftward, the closed body reacts by rotating rightward, and, conversely, when the core masses (41a, 41b) rotate rightward, the closed body reacts by rotating leftward.

A directional control sensor (61) installed on one side of the directional control motor (62) controls the direction of the closed body (10) by sensing the rotating direction of the directional control motor (62).

The number and size of the core masses (63˜70) affects the amount and smoothness of movement of the body (10).

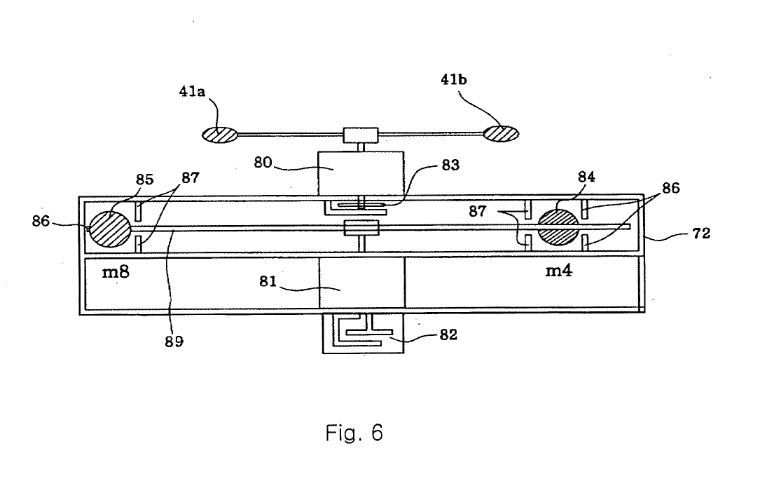

As shown in FIG. 6, both sides of the inner-guide-type single internal propulsion apparatus is depicted for properly guiding and maintaining the eccentricity of the core masses.

A power motor (81) is installed underneath the center of the guide (72). A power motor sensor (82) is installed at the lower part of the power motor (81). In order to maintain the core masses (84, 85) eccentrically with respect to the axis of the power motor (81), both an inner guide (87) and an outer guide (86) are installed along the circumference of the guide (72).

A directional control motor (80) is installed at the upper part of the guide (72). The rotating core masses (41a, 41b) are installed at end of the shaft of the directional control motor (80), for controlling the direction of the moving body (10). A directional control motor sensor (83) is installed underneath the directional control motor (80).

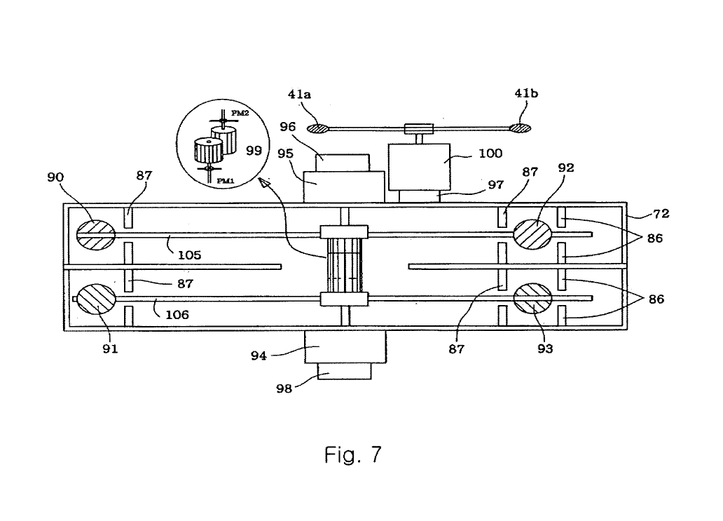

As seen in FIG. 7, both sides of the inner-guide-type paired internal propulsion system are presented with a configuration of a dual-activating system. The lower and upper power motors (94, 95) are coupled through a gear train (99) to rotate in opposite directions of each other by a speed ratio of 1:1. Each power motor sensor (96, 98) is installed at the outer ends of the lower power motor (94) and the upper power motor (95).

Due to installation of the outer guide (86) and inner guide (87), the core masses (90, 91, 92, 93) are stably guided along the cylindrical guides when the spokes (105, 106) rotate. Double the Coriolis forces are produced because of the paired internal propulsion system. In order to control the direction of the body (10), a directional control motor sensor (97) is installed underneath the directional control motor (100).

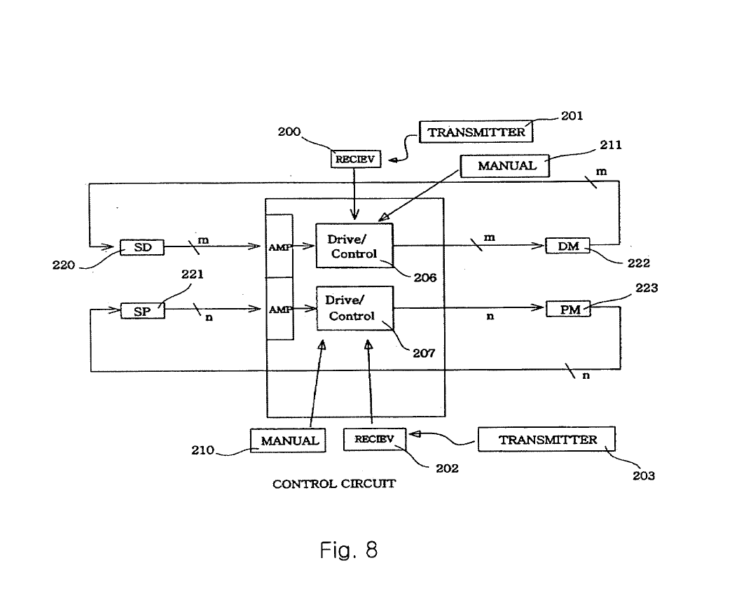

Referring to FIG. 8, a block diagram of a control circuit is illustrated, according to the present invention. The control circuit configures a directional control motor sensor (220) and a power motor sensor (221) for sensing signals, amplifiers for amplifying the sensed signals, driving control units (206, 207) for controlling the power motor (222) and direction motor (223) by feedback, receivers (200, 202) for receiving the control signals transmitted from the wireless transmitters (201, 203). The control circuit is also equipped manual controllers (210, 211) so that it is possible to operate either automatic or manual.

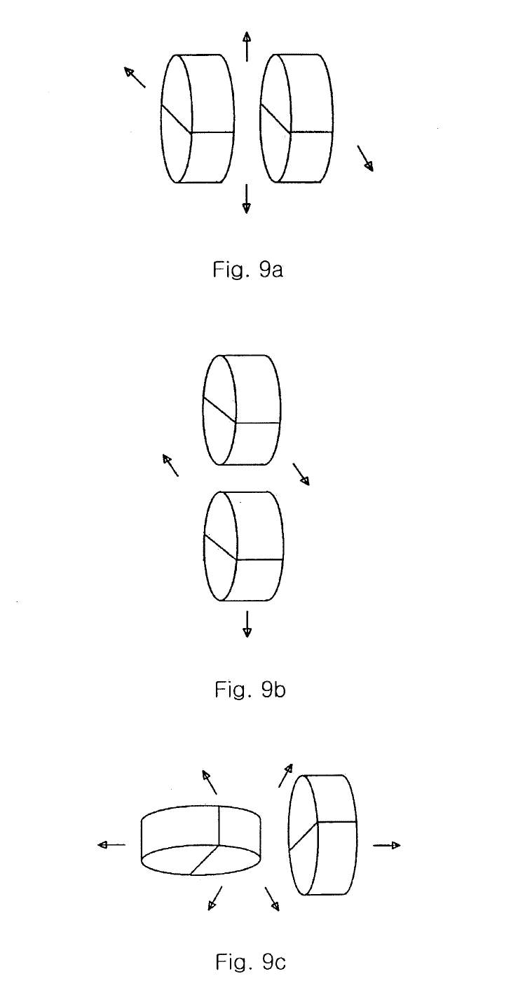

As shown in FIG. 9, the relative combinations of paired internal propulsion systems are illustrated for multiple combinations in parallel, series, and perpendicular. The combination of paired internal propulsion system is coupled in the manner that the system rotates opposite directions of each other. Thus, FIG. 9a shows a parallel combination with the paired internal propulsion systems, FIG. 9b shows a series combination with the paired internal propulsion systems, and FIG. 9c shows a perpendicular combination with the paired internal propulsion systems.

This invention can be extensively applied not only to the space-engineering field, but also to transportation industries. For example, it may be applied to satellites, space shuttles, space stations, space personal lifeboats, wheel-less toys, conveyors and transporting devices. It can be used with regard to propulsion apparatuses such as airplanes, vessels and submarines, and their respective brake systems. The invention may also be used as a propulsion device for nano-sized biological capsules, which is required precise movement to travel inside of the human body.

Until now, the Coriolis force (Fc) was limited in its application to sensors; however, this invention applies the Coriolis force to a closed system not only in a gravitational field for free linear movement, but also in a gravity-free vacuum state for free movement. The present invention therefore meets the needs of the coming space age by providing an internal propulsion system utilizing the Coriolis force (Fc) as an internal propulsion force.

Moreover, the closed system does not allow the exchange of foreign objects as does an internal combustion engine or a rocket, so it does not contribute to polluting the environment.

While the present invention has been described in detail with its preferred embodiments, it will be understood that further modifications are possible. The present application is therefore intended to cover any variations, uses or adaptations of the invention following the general principles thereof, and includes such departures from the present disclosure as come within known or customary practice in the art to which this invention pertains, within the limits of the appended claims.

What is claimed is:

1. An internal propulsion apparatus of a closed system utilizing the Coriolis force enables to generate mobility, the apparatus comprises:
a closed body (10) with a hollow interior,
a guide (72) having a plurality of slots along its cylindrical shape of lateral surface, said guide (72) being installed inside of said closed body (10) and eccentrically disposed from a center of said closed body (10),
a power motor (71) installed eccentrically from a center of said guide (72) and disposed perpendicular to said closed body (10),
a directional control means installed on an upper part of said guide (72), for controlling the direction of said closed body (10),
a plurality of spokes (39a) outwardly and radially coupled to a shaft end of said power motor (71) for rotating along with said power motor (71), said spokes (39a) being pierced through said slots of guide (72) and arranged radially around said guide (72) in certain intervals, and
a plurality of core masses (63˜70) arranged in each partition and restricted by said spokes (39a) and guide (72) for rotating with constant angular velocity by rotation of said spokes (29a) and guide (72).

2. An internal propulsion apparatus as claimed in claim 1, further comprises a sensing means (60) installed on a shaft end of said power motor (71) for sensing the number of revolutions of said power motor (71).

3. An internal propulsion apparatus as claimed in claim 1, wherein said directional control means consists a directional control motor (62) and a pair of rotating core masses (41a, 41b) perpendicularly installed on the shaft end of said directional control motor (62).

4. An internal propulsion apparatus as claimed in claim 3, further comprises a sensing means (61) installed on other shaft end of said directional control motor (62) for sensing the rotating direction of the directional control motor (62) and the moving direction of the closed body (10).

5. An internal propulsion apparatus as claimed in claim 1, wherein said plurality of spokes (39a) consists of at least one spoke and said plurality of core masses (63˜70) consists of at least one core mass, said core mass being made of either solid, liquid, gas or particle.

6. An internal propulsion apparatus as claimed in claim 1, wherein said closed body (10) is operable under the influence of either in a gravitational field, a gravity-free field, or a field of liquid state.

7. An internal propulsion apparatus as claimed in claim 1, wherein said closed body (10) is coupled to a paired closed system by multiple combinations, either parallel combination type, series combination type or perpendicular combination type, of paired closed systems.

8. An internal propulsion apparatus of a closed system utilizing the Coriolis force enables to generate mobility, the apparatus comprises:
a closed body (10) with a hollow interior,
a cylindrical guide (72) installed inside of said closed body (10),
a power motor (81) installed eccentrically from a center of said cylindrical guide (72) and disposed perpendicular to said closed body (10),
a directional control means, installed on an upper part of said guide (72), for controlling the direction of said closed body (10),
an inner guide (87) having a plurality of slots along its cylindrical shape of lateral surface, said inner guide (87) being installed inside of said cylindrical guide (72) forming partitions, and eccentrically disposed from a center of said cylindrical guide (72),
an outer guide (86) having a plurality of slots along with its cylindrical-shape of lateral surface, said outer guide (86) being installed inside of said cylindrical guide (72), forming partitions, and eccentrically disposed from a center of said cylindrical guide (72),
a plurality of spokes (39a), outwardly and radially coupled to a shaft end of said power motor (71) for rotating along with said power motor (71), said spokes (39a) being pierced through said slots of the inner and outer guides (86, 87) and arranged radially around said inner and outer guides (86, 87) in certain intervals, and
a plurality of core masses (63˜70), arranged in each partition and restricted by said spokes (39a) and inner and outer guides (86, 87) for rotating with constant angular velocity by rotation of the spokes (29a) and the inner and outer guides (86, 87).

9. An internal propulsion apparatus as claimed in claim 8, further comprises a sensing means (82) installed on a shaft end of said power motor (81) for sensing the number of revolutions of said power motor (81).

10. An internal propulsion apparatus as claimed in claim 8, wherein said directional control means consists a directional control motor (80) and a pair of rotating core masses (41a, 41b) perpendicularly installed on the shaft end of said directional control motor (80).

11. An internal propulsion apparatus as claimed in claim 10, further comprises a sensing means (83) installed on other shaft end of said directional control motor (80) for sensing rotating direction of the directional control motor (80) and the moving direction of the closed body (10).

12. An internal propulsion apparatus as claimed in claim 8, wherein said plurality of spokes (39a) consists of at least one spoke and said plurality of core masses (84˜85) consists of at least one core mass, said core mass being made of either solid, liquid, gas or particle.

13. An internal propulsion apparatus as claimed in claim 8, wherein said closed body (10) is operable under the influence of either in a gravitational field, a gravity-free field, or a field of liquid state.

14. An internal propulsion apparatus as claimed in claim 8, wherein said closed body (10) is coupled to a paired closed system by multiple combination, either parallel combination type, series combination type or perpendicular combination type of paired closed system.

15. An internal propulsion apparatus as claimed in claim 8, wherein said closed body (10) of a closed system is formed of dual layers, and rotates in opposite direction of each other.

16. An internal propulsion apparatus as claimed in claim 15, further comprises a lower power motor (94) and an upper power motor (95), a gear train (99) coupled to each shaft of said lower and upper power motors.

17. An internal propulsion apparatus as claimed in claim 15, further comprises a sensing means (96, 98) installed on each shaft end of said power motors (94, 95) for sensing the number of revolutions of said power motors (94, 95).

18. An internal propulsion apparatus as claimed in claim 15, wherein said directional control means consists a directional control motor (100) and a pair of rotating core masses (41a, 41b) perpendicularly installed on shaft end of said directional control motor (100).

19. An internal propulsion apparatus as claimed in claim 18, further comprises a sensing means (97) installed on other shaft end of said directional control motor (100) for sensing the rotating direction of the directional control motor (100) and the moving direction of the closed body (10).

20. An internal propulsion apparatus as claimed in claim 15, wherein said plurality of spokes (105, 106) consists of at least one spoke and said plurality of core masses (90˜93) consists of at least one core mass, said core mass being made of either solid, liquid, gas or particle.

21. An internal propulsion apparatus as claimed in claim 15, wherein said dual layers of closed body (10) is operable under the influence of either in a gravitational field, a gravity-free field, or a field of liquid state.

22. An internal propulsion apparatus as claimed in claim 15, wherein said dual layers of closed body (10) is coupled to a paired closed system by multiple combinations, either parallel combination type, series combination type or perpendicular combination type of paired closed system.
